(19) United States
(12) Patent Application Publication
(10) Pub. No.: US 2018/0207056 A1
(43) Pub. Date: Jul. 26, 2018

(54) Configurable Massaging Apparatus

(71) Applicants: Betty Howard, La Palma, CA (US); Reatha Howard, Los Angeles, CA (US); Anita Green, Whittier, CA (US)

(72) Inventors: Betty Howard, La Palma, CA (US); Reatha Howard, Los Angeles, CA (US); Anita Green, Whittier, CA (US)

(21) Appl. No.: 15/413,621

(22) Filed: Jan. 24, 2017

(51) Int. Cl. A61H 23/02; A61H 15/00; A47C 21/00; A47C 27/00; A47C 21/04

(52) U.S. Cl. CPC A61H 23/02; A61H 15/0078; A61H 2201/123; A47C 27/00; A47C 21/048; A47C 21/006

(57) ABSTRACT

A configurable massaging apparatus includes a mattress having opposed bottom and top surfaces and side walls connecting perimeter edges of the bottom and top walls that, together, define an interior area. The mattress includes cushioning material. The massaging apparatus includes a framework having a plurality of spaced apart massage rails situated in the interior area, each massage rail extending substantially between two opposed side walls of the mattress and defining a channel assembly along a top side thereof. A plurality of massage assemblies is coupled to the plurality of massage rails, respectively, each massage assembly being configured for movement along a respective channel assembly of a respective rail as directed by a remote control. Drive motors are coupled to respective massage assemblies causing a respective massage assembly to move along a respective massage rail when energized.

### BACKGROUND OF THE INVENTION

This invention relates generally to massaging devices and, more particularly, to a massage mattress having massaging assemblies that may be selectively positioned, configured, and energized along rails of a framework for providing user-selectable massage configurations.

Massage therapy is considered to have many health benefits, including relief from anxiety and stress, loosening of sore or overworked muscles, decreasing disability due to fibromyalgia, rehabilitating sports injuries, reducing headaches, and general feelings of wellness and relaxation. Although full-scale massage is traditionally carried out in commercial facilities by a therapist and includes pressing, rubbing, and manipulating a person's skin, tendons, ligaments, and muscles.

In addition, various mechanical devices have been proposed and sold to help a person apply massage techniques to himself or to a friend or family member. Specifically, massage chairs are known to have motorized massage devices such as rollers that can provide selective massage techniques to a person sitting in the chair. Although presumably effective for their intended purposes, the existing devices do not enable a user to be totally recumbent while receiving a massage nor can they selectively reconfigure the position of the massage assemblies so as to provide a selected massage experience.

Therefore, it would be desirable to have a configurable (and re-configurable) massaging apparatus that positions a plurality of massage assemblies at predetermined locations along the rails of a framework according to selections made by a user. Further, it would be desirable to have a configurable (and re-configurable) massaging apparatus that is actuated by a user via remote control to set up a desired configuration and pattern of massage operation.

### SUMMARY OF THE INVENTION

A configurable massaging apparatus according to the present invention includes a mattress having opposed bottom and top surfaces and a plurality of side walls connecting perimeter edges of the bottom and top walls that, together, define an interior area. A cushioning material may be situated in the mattress. The massaging apparatus includes a framework that includes a plurality of spaced apart massage rails situated in the interior area of the mattress, each massage rail having an elongate linear main rail portion extending substantially between two opposed side walls of the plurality of side walls and defining a channel assembly along a top side thereof.

A plurality of massage assemblies is coupled to the plurality of massage rails, respectively, each massage assembly being configured for movement along a respective channel assembly of a respective rail. Massage members are operatively coupled to respective massage assemblies, each massage member causing a respective massage assembly to move along a respective massage rail when energized.

Therefore, a general object of this invention is to provide a configurable massage apparatus that enables a user to select a massage configuration from predetermined settings.

Another object of this invention is to provide a configurable massage apparatus, as aforesaid, in which a plurality of massage assemblies are movably parked or positioned along respective rails of a massage framework within a mattress.

A further object of this invention is to provide a configurable massage apparatus, as aforesaid, in which predetermined massage settings may be selected and initiated using a remote control device.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is an upper elevation perspective view of a configurable massage apparatus according to a preferred embodiment of the present invention;

FIG. 1b is a lower elevation perspective view of the massage apparatus as in FIG. 1a;

FIG. 2 is an exploded view of the massage apparatus as in FIG. 1a;

FIG. 3a is a top view of the massage apparatus as in FIG. 1a;

FIG. 3b is a sectional view taken along line 3b-3b of FIG. 3a;

FIG. 3c is an isolated view on an enlarged scale taken from FIG. 3b;

FIG. 4a is a top view of the massage apparatus as in FIG. 1a;

FIG. 4b is a sectional view taken along line 4b-4b of FIG. 4a;

FIG. 5a is an isolated perspective view of a single massage rail removed from the plurality of massage rails;

FIG. 5b is a side view of the single massage rail illustrated in FIG. 5a;

FIG. 5c is an isolated view on an enlarged scale taken from FIG. 5a;

FIG. 6a is an end view of the single massage rail as in FIG. 5a;

FIG. 6b is a sectional view taken along line 6b-6b of FIG. 6a;

FIG. 6c is an isolated view on an enlarged scale taken from FIG. 6b;

FIG. 7a is an isolated perspective view of a massage assembly as in FIG. 5c;

FIG. 7b is a side view of the massage assembly as in FIG. 7a;

FIG. 8 is an exploded view of the massage assembly as in FIG. 7a;

FIG. 9a is a top view of the massage assembly;

FIG. 9b is a sectional view taken along line 6b-6b of FIG. 6a;

FIG. 10 is a perspective view of a massage assembly according to one embodiment;

FIG. 11a is a perspective view of a remote control device according to the present invention;

FIG. 11b is a front side view of the remote control device; and

FIG. 12 is a block diagram of the electronic components according to the present invention.

### DESCRIPTION OF THE PREFERRED EMBODIMENT

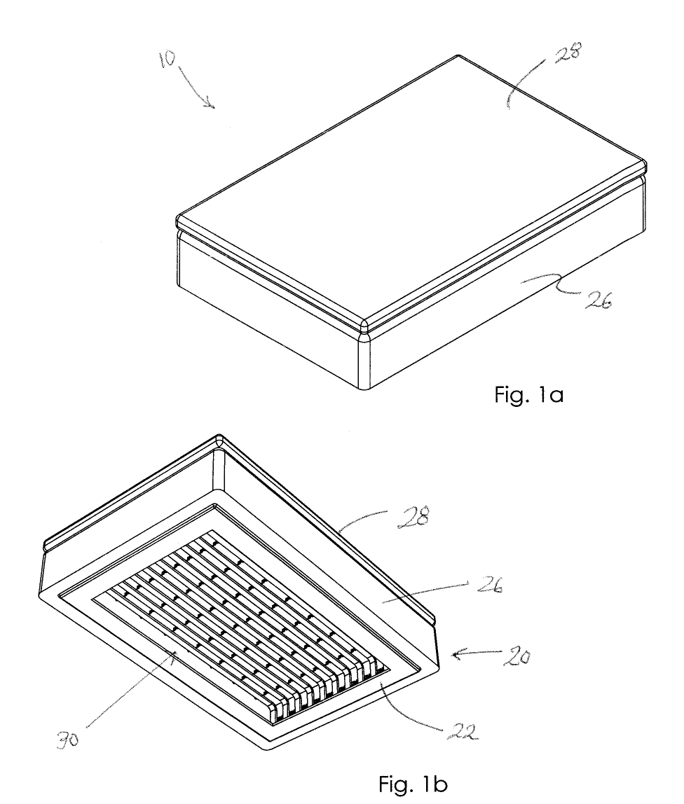

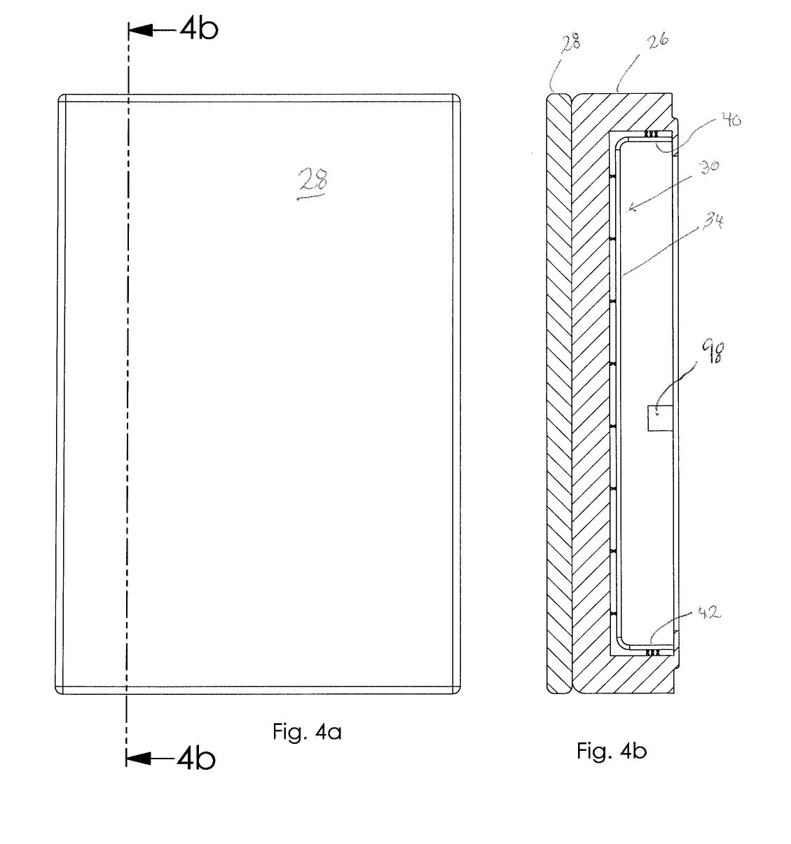

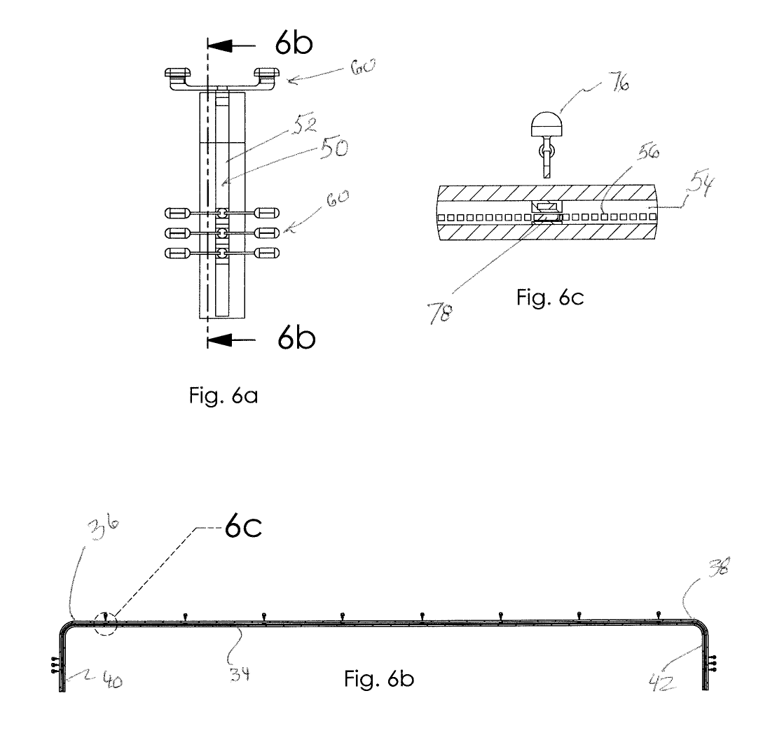

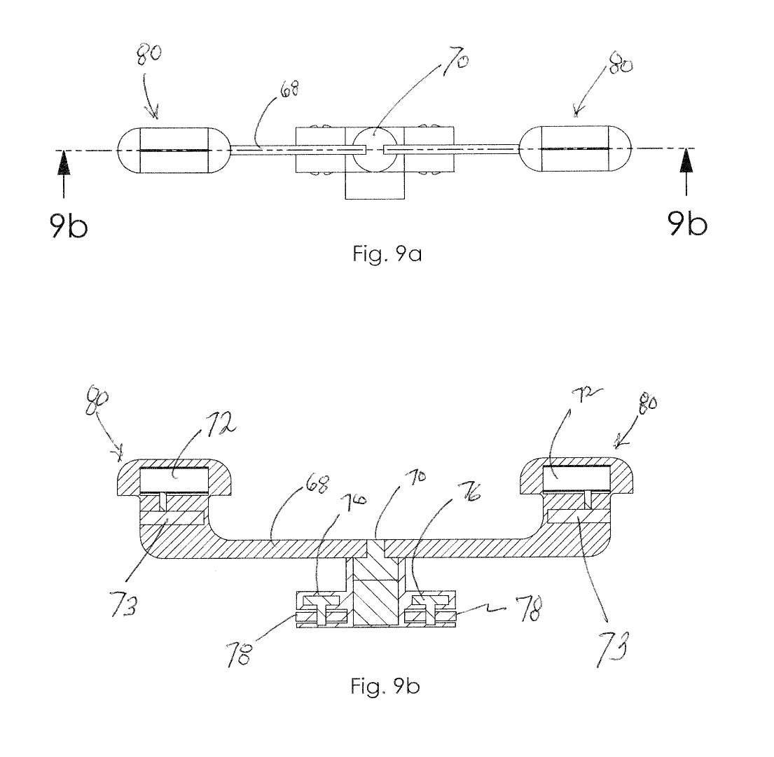

A configurable massage apparatus 10 according to a preferred embodiment of the present invention will now be described with reference to FIGS. 1 to 12 of the accompanying drawings. The configurable massage apparatus 10 includes a mattress 20, a massage framework 30 having a plurality of massage rails 32 mounted inside the mattress 20, a plurality of massage assemblies 60 coupled to respective rails 32, a plurality of drive motors 76 coupled to respective massage assemblies 60 for selectively moving the massage assemblies 60 along respective rails 32, and a plurality massage members 80 that that are configured to provide massaging action when the plurality of massage assemblies 60 are operated.

The mattress 20 has a traditional appearance and includes a planar top surface 24 and an opposed planar bottom surface 22 (shown open in FIG. 1b for clarity). A plurality of side walls 26 connects peripheral edges of the top and bottom surfaces so that, together, the mattress 20 defines an interior area. Also like a traditional mattress, a cushioning material, such as foam, down, or other types of padding, may be situated within the interior area so as to provide softness to a user lying down on the top surface 24 of the mattress 20. An additional mattress pad 28 may be removably mounted atop the top surface 24 to provide a buffer between the massage rollers and a person's body as will be described further later.

It is understood that the thicknesses of padding material shown in the drawings are illustrative only and not limiting as to the scope of the patent. In addition, use of a traditional sized mattress is merely illustrative of one embodiment of the invention; in fact, the configurable massaging apparatus 10 may be manufactured on a smaller scale, such as in the form of a portable pad, mattress overlay, chair overlay, and other smaller, thinner, or even flexible embodiments.

A massage framework 30 is mounted within the interior space of the mattress 20, the framework 30 including a plurality of spaced apart massage rails 32. Each rail has a main rail portion 34 having an elongate and substantially linear configuration extending between opposed walls of the mattress 20, e.g. between the head and foot, or between two opposed side walls. Each rail 32 defines a channel assembly 50 inset in a top of the rail 32 as will be described in more detail later.

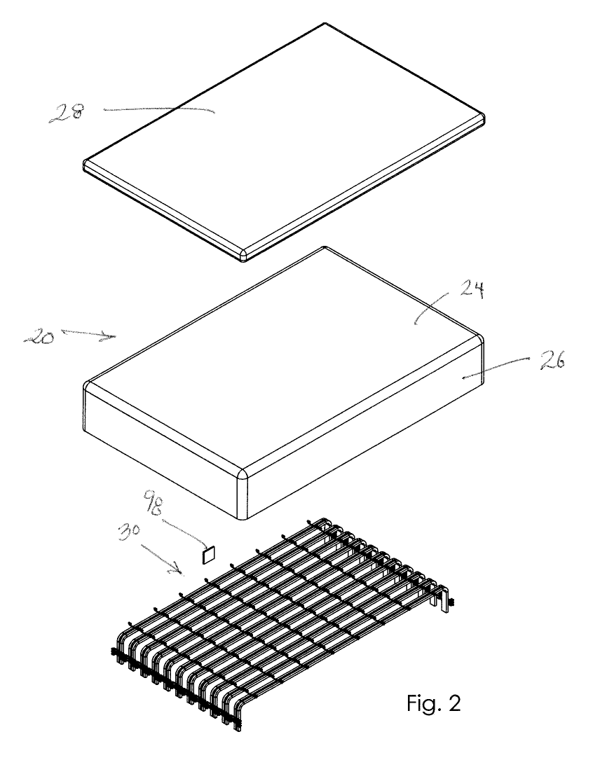

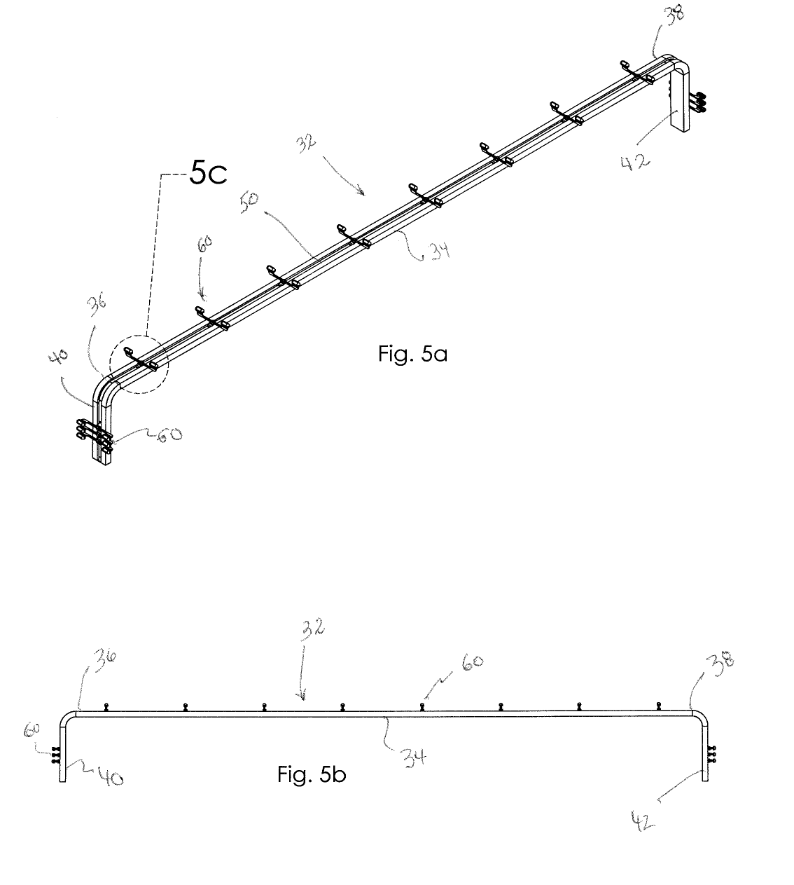

The plurality of massage assemblies 60 are movably coupled to respective massage rails 32 and movable therealong. Multiple massage assemblies 60 are coupled to each rail 32 and are independently movable between parked or stowed configurations at either end or in spaced apart use configurations along the main rail portion 34. More particularly, each massage rail 32 may include a first rail portion 40 in operative communication with a first end 36 of a respective main rail portion 34 and a second rail portion 42 in operative communication with a second end 38 of a respective main rail portion 34. The first and second rail portions may be perpendicular and turned downwardly from the respective ends of the main rail portion 34 and configured so as to receive respective massage assemblies 60 when parked or stowed (FIGS. 2 and 5a).

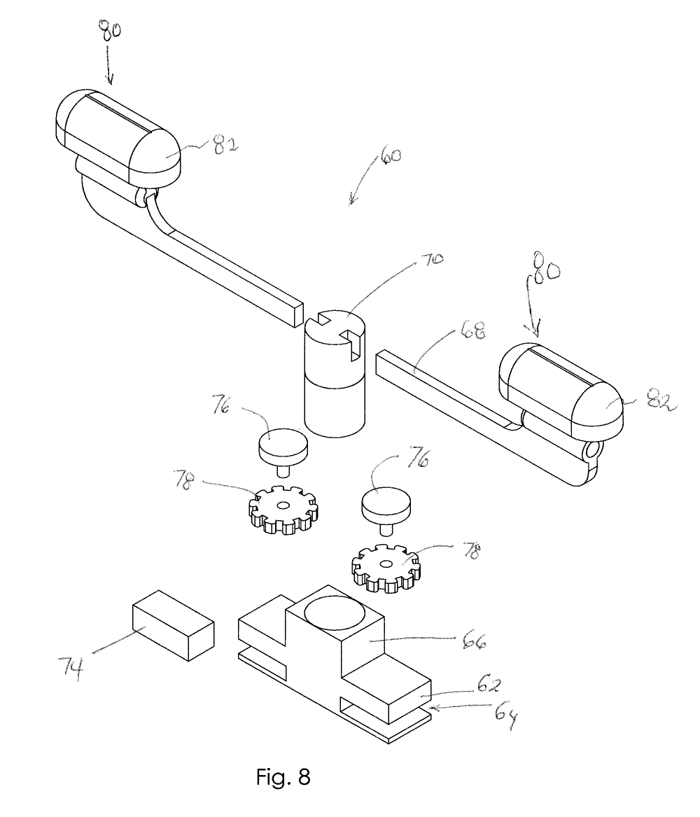

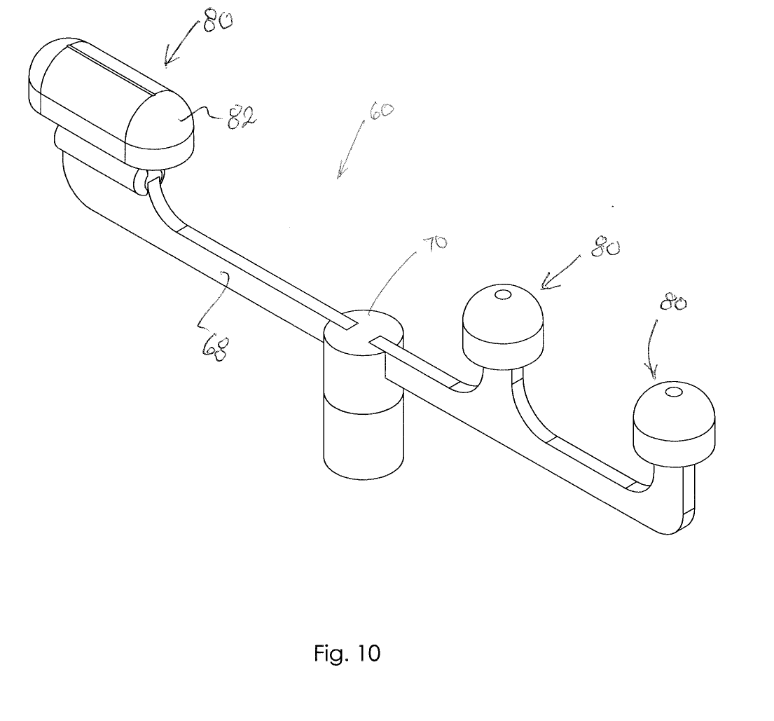

The plurality of massage members 80 is operatively coupled to respective massage assemblies 60. Preferably, a pair of massage members 80 is associated with each massage assembly 60 (FIG. 8) as will be described below in more detail although it would also work for a single massage member 80 to be included on each massage assembly 60. In an embodiment, different quantities or arrangement of massage members 80 may be associated with a single massage assembly 60 (FIG. 10). It is understood that a massage member 80 may include or be configured as a protective massage housing 82 coupled to the massage assembly 60. The massage member 80, via its housing 82, may have rounded corners or an overall ball shape configuration that provides the feeling of a roller or a kneading effect upon a user's muscles when the user is recumbent upon the mattress 20 and the configurable massaging apparatus 10 is energized. In other words, a user's muscles are massaged as respective massage assemblies 60 are moved along respective massage rails 32 as described above and, further, when the guide arm 68 is rotated as will be described below. In another embodiment (not shown), each massage member 80 may include a vibration motor configured to vibrate when energized so as to provide enhanced massaging effects.

Movement of respective massage assemblies 60 along a respective massage rail 32 is accomplished by engagement of a massage assembly 60 in a channel assembly 50 defined by the massage rail 32. The channel assembly 50 includes an access passage 52 (i.e. a portal) defined by a top wall of the massage rail 32, the access passage 52 having a generally upright or vertical configuration. Further, the channel assembly 50 includes a lower groove 54 in communication with the access passage 52 and configured to extend outwardly in opposed directions under a top wall of the massage rail 32. End walls, i.e. walls at opposed ends of the lower groove 54 may define a gear track 56 configured to receive gear teeth as will be described later. It is understood that the access passage 52 and lower groove 54 combine as the “groove” element in a tongue and groove arrangement as will become apparent below.

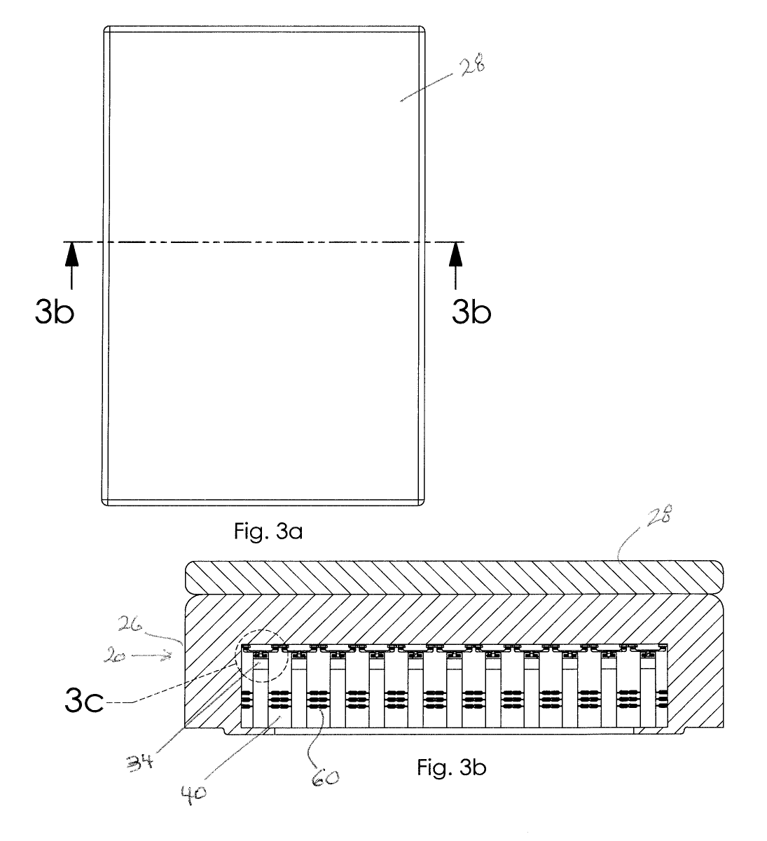

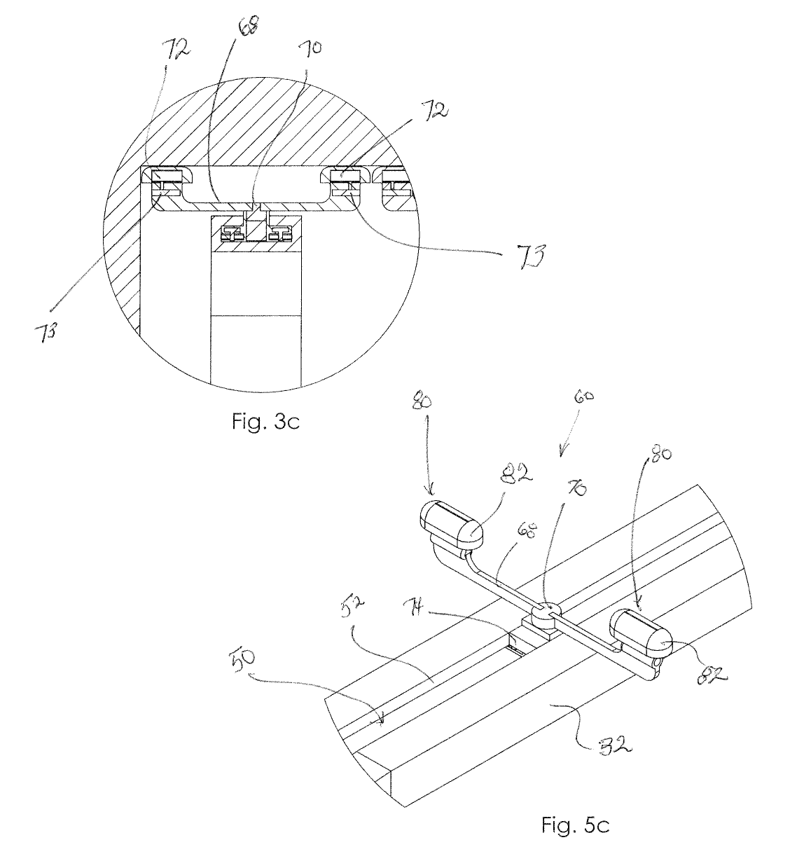

Correspondingly, each massage assembly 60 includes a lower section 62 having a configuration that is complementary to a configuration of said lower groove 54, the lower section defining at least one but preferably a pair of opposed slots 64. Further, each massage assembly 60 includes an intermediate section 66 coupled to an associated lower section 62 and having a configuration that is complementary to a configuration of an access passage 52. Accordingly, a massage assembly 60 may be situated in the channel assembly 50 in a tongue and groove arrangement (FIGS. 3c and 5c).

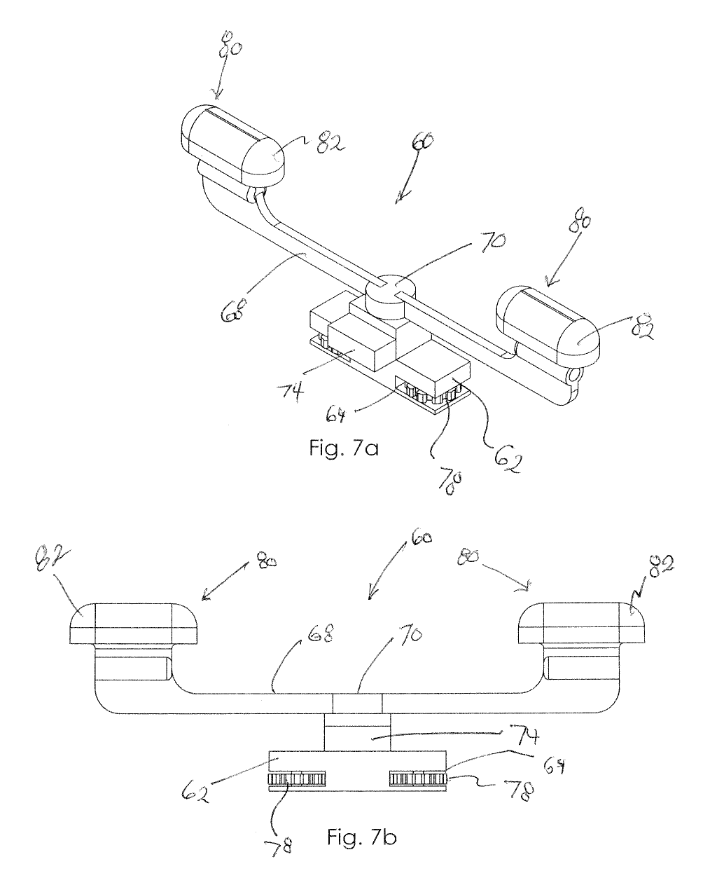

The plurality of drive motors 76 are coupled to respective massage assemblies 60 and are operative to move the respective massage assemblies 60 along respective massage rails 32 when electrically energized. A drive motor 76 may be operatively coupled to a gear 78 having teeth complementary to corresponding teeth or recesses of the gear track 56 such that when the drive motor 76 (gear) is energized, the associated gear 78 is rotated and the entire massage assembly 60 is moved in the direction corresponding to the direction the gear 78 is moving (i.e. the gear may be selectively rotated in a forward or rearward direction). The gear 78 may be positioned within the slot 64 of the lower section 62 of a respective massage assembly 60 (FIGS. 7a and 7b). Further, a drive motor battery 74 may be operatively coupled to the upper or lower section of the massage assembly 60 (FIGS. 7a and 7b) and electrically connected to respective drive motors 76 and to the hub 70 (by which the guide arm 68 may be selectively rotated). These components may be selectively actuated and energized by a processor 90 as will be described below.

The configurable massage mattress 20 may include a processor 90 and a non-volatile memory 92 in communication with the processor 90, the memory 92 including programming instructions and data corresponding to operations of specific massage members 80 and drive motors 76. Specifically, the processor 90, when executing the programming, is configured to actuate/energize specific massage members 80 to vibrate as well as to actuate respective drive motors 76 to move respective massage assemblies 60 to predetermined locations along respective massage rails 32 via respective gear tracks 56. It is understood that the electronics may be contained inside an electronics box 98 proximate the framework 30 and may include its own electronics battery 91 electrically connected to the processor 90 and memory 92 (FIG. 2)

Each massage assembly 60 may include a rotatable guide arm 68. More particularly, each guide arm 68 is rotatably mounted to a respective intermediate section 66 via a hub 70, which may include ball bearings, a pin, or other structure that allows rotatable movement of the guide arm 68. Each guide arm 68 includes first and second ends. Each hub 70 is electrically connected to the processor 90, either with wires or wirelessly. One of the plurality of massage members 80 may be mounted adjacent to respective first and second ends of the guide arm 68 (FIG. 7a). In some embodiments, more than one massage member 80 may be positioned along the guide arm 68 (FIG. 10). As illustrated, the massage members 80 need not all have the same shape configuration. Under program control, the processor 90 is configured to cause the guide arm 68 to rotate via rotation of the hub 70 to a predetermined position (FIG. 5c).

The rotation of the guide arm 68 and, consequently, of the massage members 80, causes effective massaging action to a user. It is understood that programming may include rotating one or more guide arms 68 continuously or at a predetermined frequency, with or without delay. For instance, predetermined massage members, hubs, and movement of massage assemblies may be energized in rhythmic patterns, say, from the head of the mattress 20 to the foot of the mattress 20 or side to side as may be selected by a user as described later.

In an embodiment, each massage member 80 may be associated with a heating element 72 in electrical communication with the processor 90 (via wires or wirelessly), the processor 90 being configured to energize the heating element 72. Each massage assembly 60 may include a housing 82 defining an interior space configured to receive an associated heating element 72 and an associated heater battery 73 (FIG. 8).

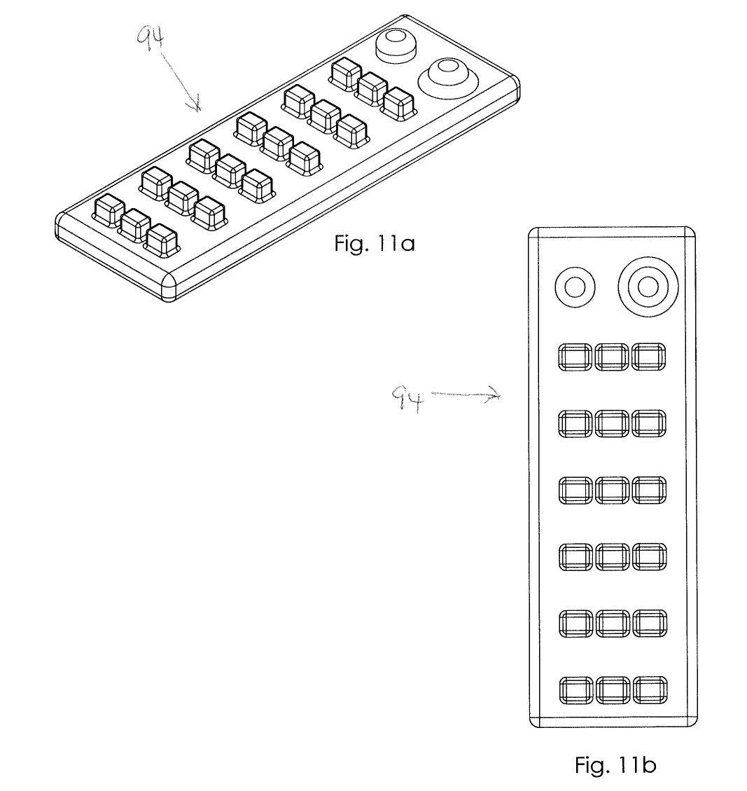

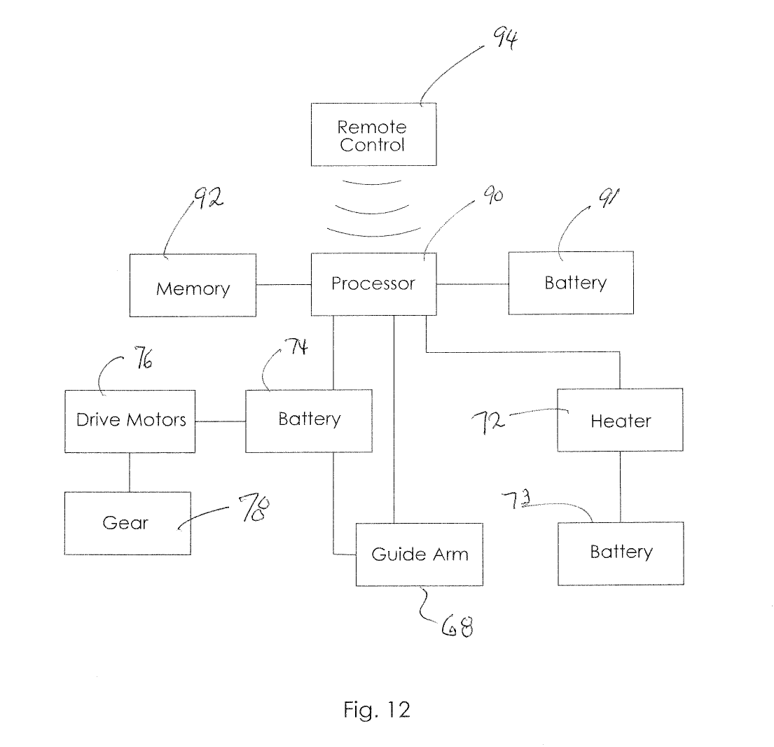

In another aspect, the configurable massaging apparatus 10 may include a remote control 94 separate and displaced from the mattress 20 and configured to enable a user to control operation of the components described above (FIG. 11a). For instance, with the push of a button, a user can initiate predetermined movements and distributions of respective massage assemblies 60 along respective massage rails 32 and then to actuate respective massage members 80 to vibrate. Various preprogrammed distributions, movements, and guide arm rotations may be selected. It is understood that the remote control 94 may include a transmitter and that a corresponding receiver in communication with the processor 90 may be included in the invention as is known in the art.

In use, a user may select a predetermined type of massage to receive from the configurable massaging apparatus 10. By this selection, such as via the remote control 94, the processor 90 causes predetermined massage assemblies 60 to move automatically to predetermined locations along respective massage rails 32 as described above. Similarly, the guide arm 68 of each massage assembly 60 may be selectively energized to rotate about a respective hub 70.

It is understood that while certain forms of this invention have been illustrated and described, it is not limited thereto except insofar as such limitations are included in the following claims and allowable functional equivalents thereof.

1. A configurable massaging apparatus, comprising:
a mattress having opposed bottom and top surfaces and a plurality of side walls connecting perimeter edges of said bottom and top walls that, together, define an interior area;
a cushioning material positioned in said interior area;
a massage framework that includes a plurality of spaced apart massage rails situated in said interior area of said mattress, each massage rail having an elongate linear main rail portion extending substantially between two opposed side walls of said plurality of side walls and defining a channel assembly along a top side thereof;
a plurality of massage assemblies coupled to said plurality of massage rails, respectively, each massage assembly being configured for movement along a respective channel assembly of a respective rail;
a plurality of drive motors operatively coupled to said plurality of massage assemblies, respectively, each drive motor causing a respective massage assembly to move along a respective massage rail when energized;
a plurality of massage members coupled to respective massage assemblies and configured to vibrate when energized.

2. The configurable massage mattress as in claim 1, wherein each channel assembly includes:
an access passage defined by said top wall of a respective rail and having an upstanding configuration;
a lower groove in communication with said access passage and configured to extend outwardly under said top side of said rail;
a gear track is positioned within said lower groove.

3. The configurable massage mattress as in claim 2, wherein each said massage assembly includes:
a lower section having a configuration that is complementary to a configuration of said lower groove, said lower section defining a slot;
an intermediate section coupled to said lower section and having a configuration that is complementary to a configuration of said access passage, wherein said massage assembly is selectively situated in said channel assembly in a tongue and groove arrangement.

4. The configurable massage mattress as in claim 3, wherein each said massage assembly is associated with a respective drive motor operatively coupled to a gear that is selectively engaged with said gear track, said at least one drive motor being in electrical communication with a power source and configured to energize said gear to move said massage assembly along said gear track when said drive motor is energized.

5. The configurable massage mattress as in claim 1, wherein a predetermined portion of said plurality of said massage assemblies are coupled to each respective massage rail and configured to move selectively therealong when actuated.

6. The configurable massage mattress as in claim 5, wherein:
each massage rail includes a first rail portion in operative communication with a first end of a main rail portion and a second rail portion in operative communication with a second end of a main rail portion;
said predetermined portion of said massage assemblies are “parked” on one of said first rail portion or said second rail portion when not spaced distributed along said main rail portion.

7. The configurable massage mattress as in claim 1, further comprising a processor in electrical communication with each drive motor of said plurality of drive motors and configured to selectively energize respective drive motors to move respective massage assemblies to predetermined positions along a respective massage rail.

8. The configurable massage mattress as in claim 4, further comprising a processor in electrical communication with each drive motor of said plurality of drive motors and configured to selectively energize respective drive motors to move respective massage assemblies to predetermined positions along a respective massage rail.

9. The configurable massage mattress as in claim 8, wherein each massage assembly includes:
a guide arm rotatably mounted to said intermediate section via a hub and having opposed first and second ends, said hub being electrically connected to said processor;
wherein one of said plurality of massage members is mounted to respective first and second ends of said guide arm;
wherein said processor is configured to selectively energize a respective hub to rotate a respective guide arm.

10. The configurable massage mattress as in claim 1, wherein at least one of said plurality of massage members is associated with a heating element and is configured to energize said heating element.

11. The configurable massage mattress as in claim 9, wherein:
each massage assembly includes a motor housing defining an interior space;
a respective massage member is positioned in said interior space and electrically connected to a motor battery; and
a heating element positioned in said interior space and electrically connected to said motor battery and to said massage member, said massage member configured to energize said heating element.

12. The configurable massage mattress as in claim 7, comprising:
a non-volatile memory in data communication with said processor, a plurality of programming instructions executable by said processor being stored in said memory;
wherein said processor, when executing respective programming instructions, causes respective drive motors to move respective massage assemblies to corresponding locations along respective massage rails;
wherein said processor, when executing respective programming instructions, causes respective hubs to rotate respective guide arms of respective massage assemblies;
wherein said processor, when executing respective programming instructions, causes respective massage members to vibrate.
